(19) United States
(12) Patent Application Publication
(10) Pub. No.: US 2012/0300005 A1
(43) Pub. Date: Nov. 29, 2012

(54) INKJET RECORDING APPARATUS

(75) Inventors: Kiyoshi SUGIMOTO, Kuwana-shi (JP); Shinya YAMAMOTO, Nagoya-shi (JP)

(73) Assignee: BROTHER KOGYO KABUSHIKI KAISHA, Nagoya-shi (JP)

(21) Appl. No.: 13/561,224

(22) Filed: Jul. 30, 2012

Related U.S. Application Data
(62) Division of application No. 12/361,518, filed on Jan. 28, 2009, now Pat. No. 8,251,507.

(30) Foreign Application Priority Data
Jan. 28, 2008 (JP) 2008-015784

(51) Int. Cl. B41J 2/01

(52) U.S. Cl. 347/104

(57) ABSTRACT

An inkjet recording apparatus includes: an ink ejection head having ink ejection openings; a conveyance mechanism which is disposed below the ink ejection head and conveys a recording medium facing the ink ejection openings; a recording medium feeder which is disposed below the conveyance mechanism, is capable of stocking therein a recording medium, and feeds a recording medium to the conveyance mechanism; a refeeder which is partially disposed below the recording medium feeder and which refeeds, to the conveyance mechanism, a recording medium having conveyed by the conveyance mechanism; and an ink reservoir which is disposed below the refeeder and reserves therein ink to be fed to the ink ejection head.

The present application claims priority from Japanese Patent Application No. 2008-015784, which was filed on Jan. 28, 2008, the disclosure of which is herein incorporated by reference in its entirety.

### BACKGROUND OF THE INVENTION

1. Field of the Invention

The present invention relates to an inkjet recording apparatus which ejects ink.

2 Description of Related Art

Japanese Unexamined Patent Publication No. 2003-182113 (Tokukai 182113/2003) discloses a color inkjet copier including: a recording unit which conducts recording on a sheet which is a recording medium; a conveyor which is disposed below the recording unit and conveys a sheet; a paper feeder which is disposed below the conveyor and feeds a sheet to the conveyor; and ink containers which are disposed below the paper feeder. This color inkjet copier is configured to conduct recording on only one surface of a sheet.

### SUMMARY OF THE INVENTION

In order to conduct recording on both surfaces of a sheet using the color inkjet copier of this publication, it is necessary to provide a refeed path for turning over a sheet that has received recording on one surface thereof and refeeding the sheet to the feeder. However, in the case where the refeed path is provided between the conveyor and the paper feeder in this color inkjet copier, a sheet has to be turned over in the refeed path at a small radius of curvature, which increases the chance of jamming. In the case where the refeed path is provided below the ink containers, if ink leaks from an ink container, the leaking ink soils the refeed path and is transferred to a sheet conveyed on the refeed path. As a result, the sheet is soiled.

An object of the present invention is to provide an inkjet recording apparatus capable of decreasing the chance of jamming and capable of preventing a recording medium from being soiled even if ink leakage occurs.

An inkjet recording apparatus of the present invention includes: an ink ejection head having ink ejection openings; a conveyance mechanism which is disposed below the ink ejection head and conveys a recording medium facing the ink ejection openings; a recording medium feeder which is disposed below the conveyance mechanism, is capable of stocking therein a recording medium, and feeds a recording medium to the conveyance mechanism; a refeeder which is partially disposed below the recording medium feeder and which refeeds, to the conveyance mechanism, a recording medium having conveyed by the conveyance mechanism; and an ink reservoir which is disposed below the refeeder and reserves therein ink to be fed to the ink ejection head.

In the structure of the inkjet recording apparatus of the present invention, the ink reservoir is disposed below the refeeder. Therefore, even if the ink leaks from the ink reservoir, it is possible to prevent the leaking ink from soiling a recording medium in the refeeder. In addition, the refeeder is disposed not above the recording medium feeder, but below the recording medium feeder. This arrangement increases the radius of curvature of a recording medium turned over in the refeeder, and thereby decreases the chance of jamming.

### BRIEF DESCRIPTION OF THE DRAWINGS

Other and further objects, features and advantages of the invention will appear more fully from the following description taken in connection with the accompanying drawings in which:

FIG. 1 is a perspective view illustrating an external appearance of an ink-jet printer of an embodiment of the present invention;

FIG. 2 is a cross-sectional side view of the ink-jet printer viewed along the direction of arrows II in FIG. 1;

FIG. 3 is a cross-sectional side view of the ink-jet printer with a refeed cassette moved toward the outside of a housing; and

FIGS. 4A, 4B, and 4C are schematic views for explanation of movement of a belt roller.

### DESCRIPTION OF THE PREFERRED EMBODIMENTS

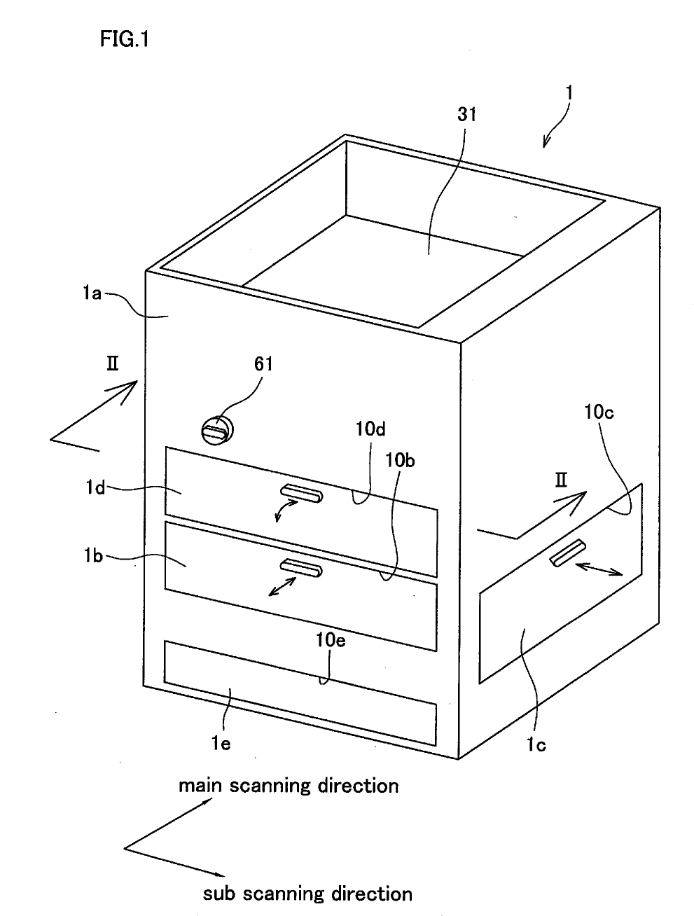

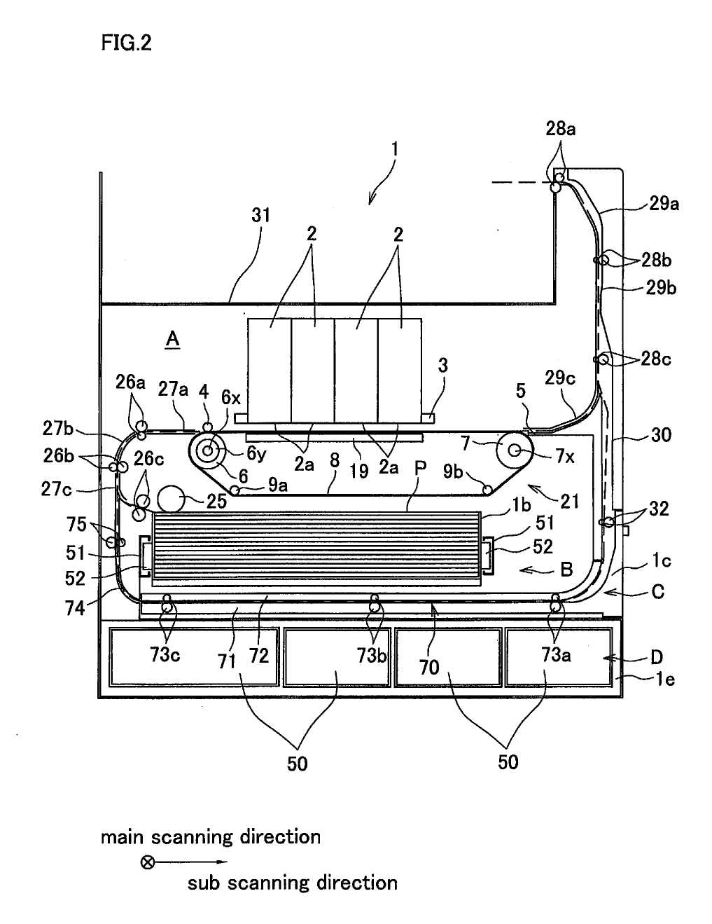

The following describes a preferred embodiment of the present invention, with reference to attached drawings. This embodiment deals with an application of the present invention to an inkjet printer which records text, images, or the like on a recording sheet by ejecting ink. FIG. 1 is a perspective view illustrating an external appearance of the ink-jet printer of the embodiment of the present invention. FIG. 2 is a cross-sectional side view of the ink-jet printer viewed along the direction of arrows II in FIG. 1.

As shown in FIG. 1, an ink-jet printer 1 (inkjet recording apparatus) has a housing 1a of a rectangular parallelepiped shape. The ink-jet printer 1 has, on its front surface (a surface close to a viewer in FIG. 1), from the top: a rotating member 61 which is rotated by a user; an opening 10d; a door 1d which is fitted to the opening 10d and is openable and closable about a horizontal shaft located at its lower end; an opening 10b through which a paper feed cassette 1b (recording medium feeder) is inserted into the ink-jet printer 1; and an opening 10e through which an ink tank cassette 1e is inserted into the ink-jet printer 1. The ink-jet printer 1 has, on the right side surface thereof, an opening 10c through which a refeed cassette 1c is inserted into the ink-jet printer 1. Further, the ink-jet printer 1 includes a paper discharger 31 on its upper surface. The door 1d is disposed so as to face a later mentioned conveyance unit 21 with respect to a main scanning direction of the housing 1a, that is, a direction perpendicular to a plane of FIG. 2.

Next, the internal structure of the ink-jet printer 1 will be described with reference to FIG. 2. As shown in FIG. 2, in the housing 1a, the ink-jet printer 1 has, from the top: four ink-jet heads 2 (ink ejection head), the conveyance unit 21, the paper feed cassette 1b, the refeed cassette 1c, and the ink tank cassette 1e. The inside of the housing 1a of the ink-jet printer 1 is divided into four spaces A, B, C, and D, from the top.

In the space A, there are disposed: the four ink-jet heads 2 which respectively eject inks of magenta, cyan, yellow, and black, and each of which has a plurality of nozzles 2a (ink ejection openings); and the conveyance unit 21 which conveys a sheet P so that the sheet P faces the nozzles 2a.

In the space B, the paper feed cassette 1b is disposed. The paper feed cassette 1b is detachable from the housing 1a, and is configured to send one sheet P after another to the conveyance unit 21 so that one surface of the sheet P faces the nozzles 2a. The space B communicates with the opening 10b. The paper feed cassette 1b is detached from the housing 1a in the main scanning direction.

In the space C, the refeed cassette 1c is disposed. The refeed cassette 1c is detachable from the housing 1a, and is configured to turn over the sheet P that has been conveyed by the conveyance unit 21, so that the other surface of the sheet P faces the nozzles 2a, and then to refeed the sheet P to the conveyance unit 21. The space C communicates with the opening 10c. The refeed cassette 1c is detached from the housing la in a sub scanning direction perpendicular to the main scanning direction, that is, in the direction from the left to right in FIG. 2.

In the space D, the ink tank cassette 1e is disposed. The ink tank cassette 1e has four ink tanks 50 (ink reservoir) which reserve inks therein to be fed to the four ink-jet heads 2, respectively. The space D communicates with the opening 10e. The ink tank cassette 1e is detached from the housing 1a in the main scanning direction.

In short, in the housing 1a, the conveyance unit 21 is disposed below the four ink-jet heads 2; the paper feed cassette 1b is disposed below the conveyance unit 21; the refeed cassette 1c is disposed below the paper feed cassette 1b; and the four ink tanks 50 are disposed below the refeed cassette 1c.

The ink-jet printer 1 has a sheet conveyance path formed therein, along which a sheet P (recording medium) is conveyed from the paper feed cassette 1b to the paper discharger 31. The paper feed cassette 1b is capable of stocking therein a stack of sheets P. The sheets P stocked in the paper feed cassette 1b are picked up by a pickup roller 25 one by one from a top-most sheet P. A picked sheet P is sent, while being guided by guides 27a, 27b, and 27c and gripped by pairs of rollers 26a, 26b, and 26c, to the conveyance unit 21 so that one surface of the sheet P faces the nozzles 2a.

The pickup roller 25 is mounted on the paper feed cassette 1b. The paper feed cassette 1b has, at both ends thereof in the sub scanning direction, slide members 52 respectively, which are slidable relative to the respective supports 51 each fixed to the housing 1a. In other words, the paper feed cassette 1b can be moved in the main scanning direction by sliding the slide members 52 along the respective supports 51.

The conveyance unit 21 has: two belt rollers 6 and 7; an endless conveyor belt 8 looped around the rollers 6 and 7; and tension rollers 9a and 9b. The tension rollers 9a and 9b each contacts the internal surface of the lower loop of the conveyor belt 8 and exerts a downward force onto the conveyor belt 8, thereby applying tension to the conveyor belt 8. The belt roller 7 is a drive roller and rotates clockwise in FIG. 2 driven by a not-shown conveyance motor fixed to a shaft 7x of the belt roller 7. The belt roller 6 is a driven roller and rotates clockwise in FIG. 2 as the conveyor belt 8 travels due to the rotation of the belt roller 7.

As described later, the driven belt roller 6 is movable downward to: the space B emptied due to the detachment of the paper feed cassette 1b from the housing 1a; and the space C emptied due to the detachment of the refeed cassette 1c from the housing 1a. That is, the space B is a space for receiving the paper feed cassette 1b, and also a space in which a part of the conveyance unit 21 is positioned when the belt roller 6 moves downward. In addition, the space C is a space for receiving the refeed cassette 1c, and also a space in which a part of the conveyance unit 21 is positioned when the belt roller 6 moves downward.

The external surface of the conveyor belt 8 has been treated with silicone to achieve adhesiveness. A nip roller 4 is disposed in the sheet conveyance path so as to face the belt roller 6 with the conveyor belt 8 interposed therebetween. The nip roller 4 presses down the sheet P sent from the paper feed cassette 1b onto the external surface of the conveyor belt 8. The sheet P pressed onto the external surface of the conveyor belt 8 is conveyed to the right, while being held on the external surface by the adhesiveness of the external surface.

Also in the sheet conveyance path, a peel plate 5 is provided so as to face the belt roller 7 with the conveyor belt 8 interposed therebetween. The peel plate 5 peels, from the external surface, the sheet P held by the external surface of the conveyor belt 8. The sheet P peeled by the peel plate 5 from the external surface of the conveyor belt 8 is sent upward while being guided by guides 29a, 29b, and 29c and gripped by pairs of rollers 28a, 28b, and 28c, and then discharged to the paper discharger 31 through an opening 30 formed in an upper part of the housing 1a.

In the meantime, one roller of each pair of rollers 28a, 28b, 28c is a switchback roller which is rotatable in a direction opposite to the rotation direction for sending and discharging a sheet P from the conveyor belt 8 to the paper discharger 31. Therefore, the sheet P peeled by the peel plate 5 from the external surface of the conveyor belt 8 is first sent upward while being guided by the guides 29a, 29b, and 29c and gripped by the pairs of rollers 28a, 28b, and 28c; and then sent to the refeed cassette 1c below, while being guided by a guide 30 and gripped by a pair of rollers 32, by rotation of the pairs of rollers 28a, 28b, and 28c in the opposite direction.

The refeed cassette 1c has: a lower guide 71; an upper guide 72; and pairs of rollers 73a, 73b, and 73c. The lower guide 71 is formed of, in the cross section, a portion extending in a vertical direction, i.e., an up and down direction in FIG. 2; a portion extending in the main scanning direction; and a curved portion between these portions. There is a predetermined gap between the upper guide 72 and the lower guide 71, which gap forms a refeed path 70 for a sheet P. The sheet P sent downward while being guided by the guide 30 and gripped by the pair of rollers 32 is sent in a direction opposite to a conveyance direction of a sheet P conveyed by the conveyor belt 8, while being guided by the upper guide 72 and the lower guide 71 and gripped by the pairs of rollers 73a, 73b, and 73c. At this time, skew of the sheet P is corrected by a not-shown skew correction roller.

Then, while being guided by the guides 27a, 27b, and 27c and a guide 74, and gripped by the pairs of rollers 26a and 26b and a pair of rollers 75, the sheet P is sent to the conveyance unit 21 so that the other surface of the sheet P faces the nozzles 2a. That is, one surface of a sheet P faces the nozzles 2a when the sheet P is conveyed from the paper feed cassette 1b to the conveyance unit 21, and then the back surface of the sheet P faces the nozzles 2a when the sheet P is conveyed from the refeed path 70 to the conveyance unit 21. As a result, the sheet P receives printing on both surfaces thereof. Note that the refeed path 70 is constituted by: the guide 30; the upper guide 72; the lower guide 71; and the guides 27a, 27b, 27c, and 74. The guides 27a, 27b, 27c, and 74 forms a u-turn path for reversing the traveling direction of the sheet P.

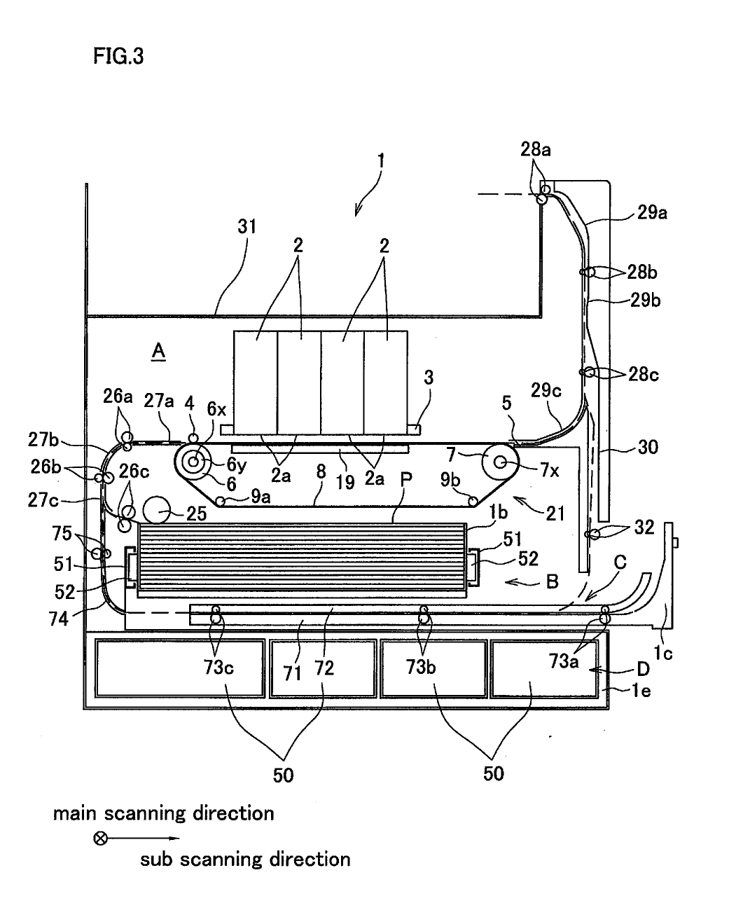

As shown in FIG. 3, the refeed cassette 1c is detachable from the housing 1a in the conveyance direction of a sheet P conveyed by the conveyor belt 8 (in the sub scanning direction). Assuming that the detaching direction of the refeed cassette 1c is a direction perpendicular to the conveyance direction, i.e., the main scanning direction, a sheet P partially remaining in the refeed cassette 1c tears when the refeed cassette 1c is pulled out from the housing 1a. However, since the detaching direction of the refeed cassette 1c corresponds to the conveyance direction (sub scanning direction), it is possible to easily find a sheet P remaining in the housing 1a when the refeed cassette 1c is pulled out from the housing 1a, and therefore to easily clear jam from the refeed path 70.

The four ink-jet heads 2 each extending in the main scanning direction are aligned in the sub scanning direction and supported by the housing 1a via a frame 3. That is, the ink-jet printer 1 is a line-type color ink-jet printer capable of conducting printing on both surfaces of a sheet P. On the under surface of each ink-jet head 2, a plurality of nozzles 2a are formed.

In the loop of the conveyor belt 8, a platen 19 having a nearly rectangular-parallelepiped shape is disposed so as to face the four ink-jet heads 2. The upper surface of the platen 19 contacts the internal surface of the upper loop of the conveyor belt 8, and supports the conveyor belt 8 from the inner periphery of the conveyor belt 8. With this, the external surface of the upper loop of the conveyor belt 8 is facing and parallel to the under surfaces of the ink-jet heads 2, i.e., the nozzles 2a; and a small gap is created between the nozzles 2a and the external surface of the conveyor belt 8. This gap constitutes a part of the sheet conveyance path. When a sheet P held on and conveyed by the external surface of the conveyor belt 8 passes immediately under the four ink-jet heads 2 sequentially, different colors of ink are respectively ejected onto an upper surface of the sheet P, thereby producing a desired color image on the sheet P.

The ink-jet heads 2 are respectively connected to the ink tanks 50 in the ink tank cassette 1e disposed at a lower part of the housing 1a. In other words, the four ink tanks 50 respectively reserve therein different colors of ink corresponding to the respective ink-jet heads 2, and the ink is supplied from each ink tank 50 to the associated ink-jet head 2 via a not-shown tube or the like. Each of the four ink tanks 50 extends in the main scanning direction, and has a length in the sub scanning direction longer than that in the vertical direction. The four ink tanks 50 entirely overlap one another when the ink tanks 50 are projected onto a vertical plane in a horizontal direction. This makes it possible to shorten the length of the printer 1 in the vertical direction, thereby to downsize the printer 1 in the vertical direction.

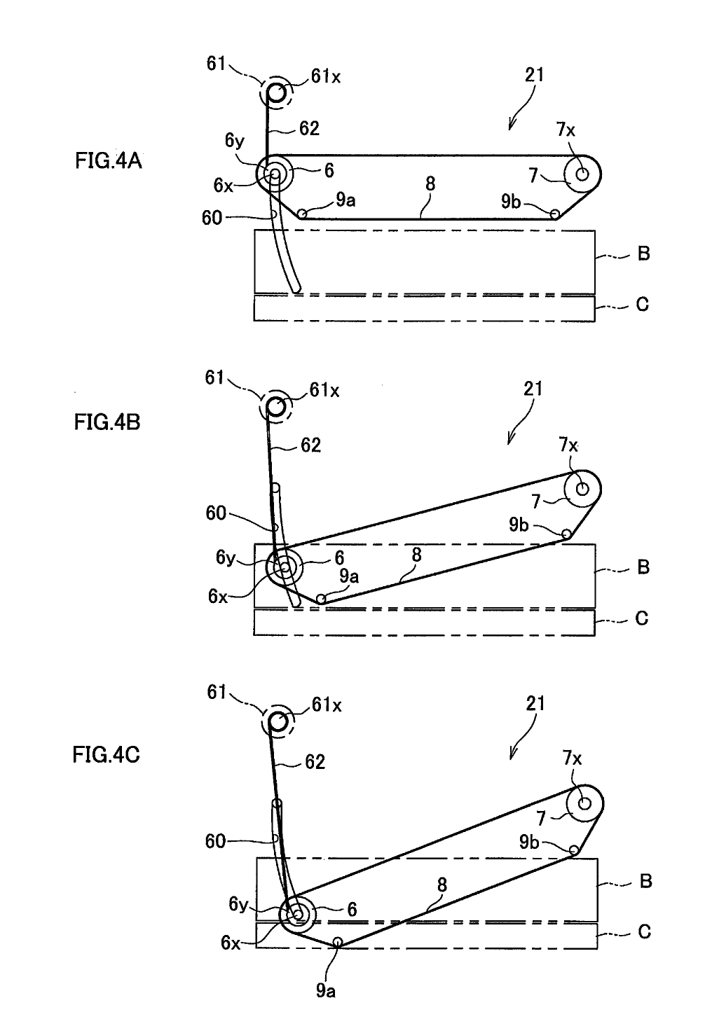

The following describes movement of the belt roller 6, with reference to FIGS. 4A, 4B, and 4C. These figures are schematic views for explanation of the movement of the belt roller.

At both ends of the belt roller 6 in its axial direction, rods 6x are respectively fixed so that the rods 6x axially protrude from the respective ends. The rods 6x respectively penetrate slits 60 each formed in a printer main body. Each slit 60 is a long narrow opening having: an upper end leveled with a corresponding rod 6x being in normal printing operation shown in FIG. 2; and a lower end positioned in the vicinity of the boundary between the space B and the space C. From the upper end to the lower end, the slit extends, obliquely downward to the right, in an arc about the shaft 7x of the belt roller 7.

FIGS. 4A, 4B, and 4C each illustrates one of the rods 6x of the belt roller 6, which rod 6x is inserted through the associated slit 60. At one end of the belt roller 6, a stepped portion 6y having a larger diameter than that of the rod 6x is formed in such a manner that the stepped portion 6y is interposed between the one end and the rod 6x. To the outer periphery of the stepped portion 6y, one end of a connection member 62 such as wire is fixed. The other end of the connection member 62 is fixed to and wound around a shaft 61x of the rotating member 61. In a state shown in FIG. 4A, that is, during the normal printing operation, torque is applied clockwise to the shaft 61x of the rotating member 61, using a gear, clutch spring or the like, to prevent the connection member 62 from being unwound.

When clearing a jammed sheet P, a user of the printer 1 first pulls out the paper feed cassette 1b in the direction toward a viewer in FIG. 1, and detaches the paper feed cassette 1b from the housing 1a. This empties the space B (see FIG. 2).

Then, as the rotating member 61 is rotated counterclockwise in FIG. 4A, the connection member 62 is unwounded from the shaft 61x. Along with this, the distance between the shaft 61x and the stepped portion 6y in the connection member 62 becomes longer, and the rod 6x slides along the associated slit 60, obliquely downward to the right, in an arc about the shaft 7x of the belt roller 7, and then stops at a certain point of the slit 60 in the space B before reaching the lower end, as shown in FIG. 4B.

As the rod 6x moves in this manner, the belt roller 6 also moves obliquely downward to the right, in an arc about the shaft 7x of the belt roller 7. This causes a part of the conveyance unit 21, i.e., a part of the belt roller 6 and a part of the conveyor belt 8 to be positioned in the space B. In other words, the conveyance unit 21 at this time is positioned across the boundary between the space A and the space B. Although the belt roller 7 is always at a fixed position, the tension rollers 9a and 9b move, when the belt roller 6 moves, in a same manner as the belt roller 6, that is, move in an arc about the shaft 7x of the belt roller 7, in order to keep the shape of the conveyor belt 8 always constant by continuously applying constant tension to the conveyor belt 8. In addition, during the movement of the belt roller 6, torque is applied clockwise to the shaft 61x of the rotating member 61 using a gear, clutch spring or the like, to prevent the belt roller 6 from moving at excessively fast speed. In this manner, the slit 60, the rotating member 61, and the connection member 62 constitute the movement mechanism.

The movement of the belt roller 6 from the position shown in FIG. 4A to that in FIG. 4B increases the distance between the conveyor belt 8 and the ink-jet heads 2. Therefore, a sheet P jammed in the course of conveyance between the upper loop of the conveyor belt 8 and the heads 2 is easily found and removed from the housing 1a when opening the door 1d (see FIG. 1) by pulling, toward a user, the door 1d provided on the front surface of the housing 1a. Furthermore, utilizing the space B, in which the paper feed cassette 1b is disposed, eliminates the need for a space only for moving the conveyance unit 21 thereto. Accordingly, it is possible to downsize the printer 1.

In the case where it is still difficult to clear a jammed sheet P even though the distance between the conveyor belt 8 and the ink-jet heads 2 is increased, the user of the printer 1 pulls out the refeed cassette 1c to the right in FIG. 1 and detaches the refeed cassette 1c from the housing 1a. This empties the space C (see FIG. 2).

Then, as the rotating member 61 is rotated counterclockwise in FIG. 4B, the connection member 62 is unwound from the shaft 61x. Along with this, the rod 6x moves and then stops at the lower end of the slit 60 positioned in the vicinity of the boundary between the space B and the space C, as illustrated in FIG. 4C. With this movement of the rod 6x, the belt roller 6 also moves obliquely downward to the right, in an arc about the shaft 7x of the belt roller 7. As a result, a part of the conveyance unit 21, i.e., a part of the belt roller 6 and a part of the conveyor belt 8 is positioned in the space C. In other words, the conveyance unit 21 at this time is positioned across the boundary between the space A and the space B and the boundary between the space B and the space C. Although the belt roller 7 is at the fixed position, the tension rollers 9a and 9b move, when the belt roller 6 moves, in a same manner as the belt roller 6, that is, move in an arc about the shaft 7x of the belt roller 7, in order to keep the shape of the conveyor belt 8 always constant by continuously applying constant tension to the conveyor belt 8.

Thus, a space for moving the conveyance unit 21 thereto is enlarged by utilizing the space C for the refeed cassette 1c to be disposed therein, in addition to the space B for the paper feed cassette 1b to be disposed therein. The movement of the belt roller 6 from the position shown in FIG. 4B to that in FIG. 4C further increases the distance between the conveyor belt 8 and the ink-jet heads 2. Therefore, it is much easier to find a sheet P jammed in the course of conveyance between the upper loop of the conveyor belt 8 and the heads 2 and remove the sheet P from the housing 1a.

After the jam is cleared in this way, the opened door 1d is closed, and then the rotating member 61 is rotated clockwise in FIG. 4C. This causes the connection member 62 to be wound around the shaft 61x, and decreases the distance between the shaft 61x and the stepped portion 6y in the connection member 62. In addition, the rod 6x slides along the associated slit 60 obliquely upward to the left in an arc about the shaft 7x of the belt roller 7, and stops at the upper end of the slit 60 shown in FIG. 4A. With this movement of the rod 6x, the belt roller 6 also moves obliquely upward to the left in an arc about the shaft 7x of the belt roller 7 to return to an original position shown in FIG. 4A, that is, the position for normal printing operation. Then, the paper feed cassette 1b is re-attached to the housing 1a to be disposed in the space B, and the refeed cassette 1c is re-attached to the housing 1a to be disposed in the space C. Now the printer 1 is ready for printing. Accordingly, upon receiving a command to resume printing from a personal computer or the like, a top-most sheet P is picked up out of a stack in the paper feed cassette 1b, and printing is conducted.

As described above, in the structure of the ink-jet printer 1 of this embodiment, the ink tanks 50 are disposed below the refeed cassette 1c in the housing 1a. Therefore, even if ink leaks from an ink tank 50, it is possible to prevent the leaking ink from soiling a sheet P in the refeed cassette 1c. In addition, the refeed cassette 1c is disposed not above the paper feed cassette 1b, but disposed below the paper feed cassette 1b. This arrangement increases the radius of curvature of a sheet P turned over in the refeed path 70, and thereby decreases the chance of jamming.

A preferred embodiment of the present invention has been described above. However, the present invention should not be narrowly interpreted within the limits of such embodiment, but rather may be applied in many variations within the scope of the claims.

At a time of clearing jam in the above-described embodiment, a user pulls out the paper feed cassette 1b to detach the paper feed cassette 1b from the housing 1a, and then operates the rotating member 61, so that the belt roller 6 is moved. In short, the belt roller 6 is moved by the user's operation. However, the belt roller 6 may be moved automatically by way of control by a controller of the printer 1, without the user's operation. The following example deals with a case where the printer 1 is provided with: a sensor which detects jam of a sheet P; a sensor which detects that the paper feed cassette 1b is detached; and a motor which drives the rotating member 61. First, in response to detection of jam of a sheet P by the sensor, the controller notifies a user that jam occurs and provides a direction to pull out the paper feed cassette 1b. When the user pulls out the paper feed cassette 1b, the sensor detects that the paper feed cassette 1b is detached. Based on this detection, the controller controls the motor so as to move the belt roller 6 to the space B, which is the space for receiving the paper feed cassette 1b therein. After the belt roller 6 is moved, the controller provides the user with a direction to remove the sheet P. The user who has seen the direction opens the door 1d to remove the jammed sheet P from the housing 1a, and then closes the door 1d. Then, based on the detection that the jam of the sheet P has been cleared, the controller controls the motor so as to return the belt roller 6 to its original position. Then, the controller provides the user with a direction to attach the paper feed cassette 1b. After the paper feed cassette 1b is re-attached to the housing 1a, the controller resumes printing based on the detection by the sensor of the attachment of the paper feed cassette 1b. Note that, the detachment/attachment of the paper feed cassette 1b from/to the housing 1a may also be controlled by the controller, instead of the operation by the user, by providing appropriate mechanisms. Other various methods may be used to move the belt roller 6.

The rotating member 61 does not necessarily have to be provided on the same surface of the housing 1a as the surface having thereon the door 1d and/or the opening 10d.

In the above-described embodiment, the rotating member 61, the connection member 62, and the like are provided as a movement mechanism. However, the movement mechanism is not limited to this structure. The movement of the belt roller 6 maybe realized using other various mechanisms.

In the above-described embodiment, only the driven belt roller 6 is moved with the driving belt roller 7 fixed. However, contrary to the above embodiment, it is possible to move the belt roller 7 only, with the belt roller 6 fixed, for example. Alternatively, the entire conveyance unit 21 maybe shifted in parallel by simultaneously moving the belt rollers 6 and 7 downwardly.

In the above-described embodiment, the driven belt roller 6 is moved with the driving belt roller 7 fixed, in order to clear jam. However, for the case of no chance of jamming, a mechanism for moving the belt roller 6 may be omitted.

The detaching direction of the paper feed cassette 1b is not limited to the main scanning direction, but may be any directions. Also, the detaching direction of the refeed cassette 1c is not limited to the sub scanning direction, but may be any directions. For example, in the case where the detaching direction of the refeed cassette 1c is the main scanning direction, that direction is the same as the detaching direction of the paper feed cassette 1b and the ink tanks 50. This allows a user to detach these members in the same direction, leading to easy operation. In addition, this diminishes the limitation for installation of the apparatus. For example, walls may be provided near the both ends of the apparatus in the sub scanning direction.

In the above-described embodiment, each of the ink tanks 50 has a length in the sub scanning direction longer than that in the vertical direction. However, either one of these length may be longer than the other length. For example, in the case where there are so many ink tanks, such as ten ink tanks, the length in the vertical direction may be longer than that in the sub scanning direction, in view of space constraint.

In the above-described embodiment, the paper feed cassette 1b and the refeed cassette 1c are completely pulled out, i.e., detached from the housing 1a; however these cassettes may be partially pulled out of the housing 1a. For example, each pulled-out cassette may be held by the housing 1a just before the rear end of the cassette leaves the housing 1a.

In the above-described embodiment, the four ink tanks 50 are aligned in the sub scanning direction; however, the ink tanks 50 may be aligned in the main scanning direction.

The recording apparatus according to the present invention is not limited to an ink-jet recording apparatus, but is applicable to a thermal type recording apparatus. In addition, the application of the present invention is not limited to a line-type recording apparatus but also includes a serial-type recording apparatus having a reciprocating head. Further, the present invention is applicable not only to a printer, but also to a facsimile machine, copier, or the like.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. An inkjet recording apparatus comprising:
an ink ejection head having ink ejection openings;
a conveyance mechanism which is disposed below the ink ejection head and conveys a recording medium facing the ink ejection openings;
a recording medium feeder which is disposed below the conveyance mechanism, is capable of stocking therein a recording medium, and feeds a recording medium to the conveyance mechanism;
a refeeder which is partially disposed below the recording medium feeder and which refeeds, to the conveyance mechanism, a recording medium having conveyed by the conveyance mechanism, along a refed path which includes a first path, a second path following the first path, and a third path preceding the first path, the first path passing through a space below the recording medium feeder, the second path passing in vertical direction to the conveyance mechanism through a space at a side of the recording medium feeder, and the third path passing in vertical direction through a space at a side of the recording medium feeder;
a housing that houses the ink ejection head, the conveyance mechanism, the recording medium feeder, and the refeeder therein; and
a movement mechanism capable of moving at least a part of conveyance mechanism downward,
wherein a part of the refeeder including at least the first path is movable toward the outside of the housing in a conveyance direction of a recording medium conveyed by the conveyance mechanism,
wherein the recording medium feeder is movable toward the outside of the housing, and
wherein the movement mechanism is capable of, when at least a part of the recording medium feeder is positioned outside the housing, moving at least a part of the conveyance mechanism to a first space which is created by the movement of the recording medium feeder toward the outside of the housing.

2. The inkjet recording apparatus according to claim 1,
wherein the movement mechanism is capable of, when at least a part of the recording medium feeder and at least a part of the refeeder are positioned outside the housing, moving at least a part of the conveyance mechanism to the first space and to a it) second space which is created by the movement of the refeeder toward the outside of the housing.

3. The inkjet recording apparatus according to claim 1, wherein the refeeder is configured to reverse a traveling direction of a recording medium.

4. The inkjet recording apparatus according to claim 1, wherein a portion of the refeeder including at least the second path is not movable toward the outside of the housing in the conveyance direction.

5. The inkjet recording apparatus according to claim 1, wherein a portion of the refeeder including at least the third path is integrally formed with a portion of the refeeder including at least the first path, and is movable toward the outside of the housing in the conveyance direction.

6. The inkjet recording apparatus according to claim 1, wherein the refeeder has a lower guide and an upper guide, and the first pass is defined by the lower guide and the upper guide.

7. The inkjet recording apparatus according to claim 1, wherein the recording medium feeder is movable in a direction perpendicular to the conveyance direction,

8. The inkjet recording apparatus according to claim 1, wherein the conveyance mechanism has two belt rollers and a conveyance belt looped around the rollers, and the movement mechanism moves one of the rollers downward, while keeping the other roller in the same position.
